(19) United States
(12) Patent Application Publication
(10) Pub. No.: US 2015/0137404 A1
(43) Pub. Date: May 21, 2015

(54) Processes for Making Functionally Graded Materials and Products Produced by These Processes

(71) Applicant: Lev Tuchinskiy, Houston, TX (US)

(72) Inventor: Lev Tuchinskiy, Houston, TX (US)

(21) Appl. No.: 14/279,707

(22) Filed: May 16, 2014

Related U.S. Application Data
(60) Provisional application No. 61/906,995, filed on Nov. 21, 2013.

(51) Int. Cl. B32B 27/08; C04B 35/447; B32B 27/30; C04B 35/64; B32B 15/04; B32B 27/06

(52) U.S. Cl. CPC B32B 27/08; B32B 15/04; B32B 27/06; B32B 27/308; B32B 27/302; C04B 35/64; C04B 35/447; B32B 2250/42; B32B 2266/04
USPC 264/46.1; 428/471; 428/457; 428/520; 428/310.5; 264/45.8; 264/639; 264/642; 264/173.11

(57) ABSTRACT

The invention relates to a novel process for commercial production of bulk functionally graded materials (FGM) with a per-determined axial, radial, and spherical gradient profiles. The process is based on the reiterated deformation of the layers of variable cross-section thicknesses made of different materials. That allows significant savings of time, energy and materials. Metals, ceramics, glasses and polymers in different combinations can be brought together with a continuous or stepwise gradual change from one material to another. The invention can be applied to industrial production of functionally graded materials with different types of gradient profiles, which cannot be produced by the existing technologies and which are sought by many key industries. The mechanical, thermal and optical responses of materials produced by the proposed methods are of considerable interest in optics, optoelectronics, tribology, biomechanics, nanotechnology and high temperature technology.

### CROSS-REFERENCE TO RELATED APPLICATIONS

This invention claims the benefits of the provisional patent application No. 61/906,995 (filing date Nov. 21, 2013).

### STATEMENT REGARDING FEDERALLY SPONSORED RESEARCH OR DEVELOPMENT

Not Applicable

### REFERENCE TO A SEQUENCE LISTING, A TABLE, OR A COMPUTER PROGRAM, LISTING COMPACT DISC APPENDIX

Not Applicable

### BACKGROUND OF THE INVENTION

1. Field of the Invention

The present invention relates to manufacturing process for bulk functionally graded materials (FGM) with pre-assigned axial, radial and spherical gradient profiles. The mechanical, thermal and optical response of materials with spatial gradients in composition and microstructure is of considerable interest in numerous technological areas such as tribology, optics, optoelectronics, biomechanics, nanotechnology and high temperature technology.

The term gradient is used below to refer to any one of the following: (1) a composition composed of different materials such as polymer, metal, ceramic, metal alloy, composite particle, mixed powders, multiple metals or ceramics, and the like; (2) a composition composed of materials having different morphologies, e.g., spherical, blocky, acicular, whiskers, fibrous, porous and the like; (3) a composition composed of materials having different microstructures, e.g., amorphous, crystalline, crystalline phase, and the like; or (4) a composition composed of materials exhibiting the physical properties of the aforementioned compositions (1), (2) and (3), wherein the composition exhibits a graded structure such as linear, non-linear, step functions, quadratic, polynomial, and other mathematical strategies for generation of grading as known to one of ordinary skill in the art. Gradient breadth means the distance in which a gradual variation of composition and/or microstructure takes place.

There are two main types of gradients: stepwise and continuous. Contrary to the stepwise type of FGMs, for which a variety of commercial processes has been developed, various technologies proposed for the continuous type have not yet found wide commercially viable applications because of their complexity and expensiveness. Meanwhile, the continuous gradient FGMs are of most interest in many cases. Many applications require bulk FGMs with continuous non-linear gradient profiles and with the gradient breadths as small as fractions of millimeters and as large as centimeters. Although the present invention allows for manufacturing the stepwise gradient FGMs, its major advantage is that it makes possible commercial production of bulk continuous gradient FGMs of preset gradient profiles and breadth size.

2. Description of the Related Art

The few proposed FGM fabrication methods documented in the literature are labor-intensive specialized laboratory techniques. Deposition techniques (CVD, PVD, plasma spraying, cold spraying, and electrophoresis) [1-5] suffer from the drawback of slow film-deposition rates. Sequential powder mixing, slip casting and thixotropic casting techniques [6-11] are used for fabrication of multilayer materials, in which the single sharp interface is replaced by a series of “gentle” interfaces between a series of layers of incrementally changing component ratios. However, these multilayer materials are not genuine FGMs, since mismatch still occurs at the layer interfaces, albeit of a reduced intensity. Controlled powder mixing, sedimentation and centrifugal forming, gradient slurry disintegration and deposition laser cladding as well as electrophoresis deposition, slip casting and thixotropic casting, were used for fabrication of continuous bulk FGMs [12-20] but these techniques are either too expensive for commercial production, or don't allow control of gradient profile, or put too much restrictions on the physical and chemical properties of the components that could be used for these technologies.

The new stage in the development of FGMs began with recognition that they can be produced just by stacking a set of strips with small differences in compositions via a well-known polymer extrusion technique [21-23].

U.S. Pat. No. 7,255,914 [21] describes a method for forming the multilayer FGMs that includes extruding component (a) in an extruder (A) to form a melt stream (A) and component (b) in an extruder (B) to form a melt stream (B); combining melt stream (A) with melt stream (B) in a feed block to form parallel layers (A) and (B); advancing said parallel layers through a series of multiplying elements (n) to form the multilayer FGM structure.

U.S. Pat. No. 7,002,754 [22] discloses the method for producing gradient refraction index (GRIN) lenses using multilayer co-extrusion. To obtain a FGM, a wide range of nanolayer strips of different compositions are co-extruded. Then the set of strips with different refraction indexes is stacked in the order that gives the desired composition gradient and heat-pressed into thick sheets. Gradient profile is determined by the stacking of the strips. For example, by sequentially stacking a single strip of each of the 101 compositions starting with a pure PMMA strip, then one with a 99/1 ratio of PMMA to PC, then a 98/2 ratio, to the 101st layer that is pure PC, a polymer with an axial refractive index gradient varying from 1.49 to 1.58 can be made. It is an ordered array of composite strips; on a finer scale, each of these composite strips is made up of thousands alternating PMMA and PC layers with a layer thickness of a few nanometers.

The disadvantages of the technologies described in the patents [23] and [24] associated with the need to produce a wealth of the strips of different compositions makes the processes very labor-consuming and expensive. Besides, they are not attuned to the commercial production of the bulk FGMs with radial and spherical gradients and are not intended for the materials with continuous gradients, which are required for many applications.

### REFERENCES

1. Andrew DeBiccari, Jeffrey Haynes, Method and system for creating functionally graded materials using cold spray, US Patent 20060233951 A, 2006-10-19
2. J. SOBCZAK, et al., Metallic Functionally Graded Materials: A Specific Class of Advanced Composites, J. Mater. Sci. Technol., 2013, 29(4), 297-316
3. B. Kieback, et al, Processing techniques for functionally graded materials, J. of Materials Science and Engineering, Vol. 362, 1-2, 2003, 81-106
4. Marcus A. Worsley, Et Al, Methods of Electrophoretic Deposition for Functionally Graded Porous Nanostructures and Systems thereof, US Patent Us 20130004761, 2011-06-28
5. J. Groza, et al., Methods for production of FGM net shaped body for various applications, U.S. Pat. No. 7,393,559, 2008
6. I. Santacruz, et al, Graded ceramic coatings produced by thermogelation of polysaccharides, Materials Letters, 58, (2004,) 2579-2582
7. Neri Oxman et al, Functionally Graded Rapid Prototypmg, http: matenalecology.com/Publications_FGRP.pdf
8. A. Ruys, et al., Thixotropic casting of ceramic-metal functionally gradient materials J. of Mat. Sci., 31 (1996) 4347-4355
9. A. Ruys, et al. Thixotropic casting of fibre-reinforced ceramic matrix composites, J. Mater. Sei. Lett. 13 (1994), 1323.
10. Munir, et al., Centrifugal synthesis and processing of functionally graded materials, U.S. Pat. No. 6,136,452, 2000
11. D. Seyferth, P. Czubarow, Method for preparation of a functionally gradient material, U.S. Pat. No. 5,455,000, 1995
12. M. Gupta, Functionally gradient materials and the manufacture thereof, U.S. Pat. No. 6,495,212, 2002
13. Y. Peti, et al, Producing Functionally Graded Coatings by Laser-Powder Cladding, http://www.tms.org/pubs/journals/JGM/0001/Pei/Pei-0001.html
14. Zhang Xing-Hong, et al., TiC—Ni Functionally Gradient Material Produced by SHS, Journal of Inorganic Materials, 1999, 14(2): 228-232.
15. J. Abboud, Functionally gradient titanium-aluminide composites produced by laser cladding, Journal of Materials Science, 1994
16. Fang, et al., Method for making functionally graded cemented tungsten carbide with engineered hard surface, U.S. Pat. No. 8,163,232, 2012
17. B. Marple, et al., Slip casting process and apparatus for producing graded materials, U.S. Pat. No. 5,498,383
18. A. Debiccari, et al., Method and system for creating functionally graded materials using cold spray, U.S. Pat. No. 8,349,396
19. L. Supriya, et al., Methods to fabricate functionally gradient materials and structures formed thereby, U.S. Pat. No. 8,173,259
20. F. Gallant, et al., Process for making gradient materials, U.S. Pat. No. 7,632,433
21. J. Shirk, et al., Variable refractive index polymer materials, U.S. Pat. No. 7,255,914
22. E. Baer, et al., Multilayer polymer gradient index (GRIN) lenses, U.S. Pat. No. 7,002,754
23. M. Ponting, Gradient Multilayer Films by Forced Assembly Coextrusion, Eng. Chem. Res., 2010, 49 (23), pp 12111-12118

### SUMMARY OF THE INVENTION

The invention describes the methods of producing functionally graded materials with axial, radial and spherical gradients with a predetermined gradient profiles.

In accordance with the present invention, the process for making functionally graded materials with axial gradients begins with fabrication of two layers a and b made of materials A and B correspondingly. Materials A and B are selected from the groups consisting of polymers, metals, glasses, composites, or mixtures of powders with plasticized binders. Thicknesses tₐ and t_{b} of layers A and B vary along axis x, which is directed along the layer width W The maximal thickness of the each layer is H. Variable relative thickness tₐ/H of layer a depends on its relative width x/W in the same manner as concentration C_{A} of material A in FGM with gradient breadth L depends on relative distance x/L over the concentration gradient. The variable relative thickness t_{b}/H of layer b depends on its relative width x/W in the same manner as concentration G_{B} of material B in FGM depends on relative distance x/L over the concentration gradient. Layers a and b can be produced by extrusion, rolling, die compaction, injection molding, slip casting, cutting, etc.

Then layers a and b are stacked so that together they form a bi-layer sandwich BS of a rectangular cross-section. Said sandwich BS or a stack of sandwiches BS is subjected to deformation using extrusion, rolling, drawing, die compaction, or any other appropriate technique to reduce the thicknesses of the layers and to produce a composite strip CS1 of a rectangular cross section. Stacking BS sandwiches is done so that their edges of the identical compositions are arranged one above the other. As a result of the deformation, the thicknesses of both layers a and b are reduced.

A plurality of said composite strips CS1 is assembled into a multilayer sandwich MS1 by stacking so that their edges of identical composition are arranged one above the other. Said multilayer sandwich MS1 is deformed using extrusion, rolling, drawing or any other appropriate technique to produce a new multilayer composite strip CS2 of a rectangular cross section with the thinner layers than in composite strip CS1.

If the required maximal thicknesses of layers a and b are not achieved in strip CS2, said strips CS2 are assembled in a further multilayer sandwich MS2 so that their edges of identical composition are arranged one above the other and said sandwich MS2 is deformed using extrusion, rolling, drawing or any other appropriate technique to produce a further multilayer composite strip CS3 of a rectangular cross section with the layers thinner than in multilayer composite strip CS2.

The process is repeated until the maximum thickness of layers a and b of the final multilayer composite strip is reduced to the prescribed value. Strips CS3 can be assembled in a new multilayer sandwich MS3 so that their edges of identical composition are arranged one above the other and consolidated in a compaction die or by any appropriate deformation process to produce a part of the required shape and size.

Fabrication of layers a and b, their assembling in the sandwiches and deforming the sandwiches may be performed simultaneously using several extruders and a co-extrusion die. Stacking the strips into the multilayer sandwiches can be accomplished by reeling.

Functionally graded materials with a predetermined profile of radial gradients are produced from the strips with an axial gradient by their stacking so that all edges of said strips of identical composition are arranged one above the other; fabricating elements having the shape of a circular sector with the central angle of 360°/N (where N is integer and N>2) from the stack of strips with an axial gradient using extrusion, rolling, drawing, cutting, punching, or any other appropriate technique; assembling N said elements of sector shape into a cylinder so that the edges comprising 100% material A are located in the center of said cylinder and all the edges comprising 100% material B are located at the periphery of said cylinder; and consolidating said cylinder using extrusion, rolling, drawing, die compaction, isostatic pressing, or any other appropriate technique.

In another embodiment, FGMs with a pre-assigned radial gradient profile are produced by winding a strip with an axial gradient along the gradient direction and consolidating the produced reeled cylinder by die compaction, extrusion, rolling, or any other appropriate technique.

Functionally graded materials with spherical gradients are from the cylinders with the radial gradients by placing these cylinders in a compaction die with a spherical cavity and pressing said cylinders in said spherical cavity.

### Objects and Advantages of the Invention

It is an object of the present invention to provide low-cost methods for commercial production of bulk functionally graded materials and parts with predetermined axial gradient profiles of composition, structure and properties.

It is a further object to provide a low-cost method for commercial production of the bulk functionally graded materials and parts with the predetermined radial gradient profiles of composition, structure and properties.

It is a further object to provide a low-cost method for commercial production of the bulk functionally graded materials and parts with the predetermined spherical gradient profiles of composition, structure and properties.

It is a further object to produce functionally graded materials and parts with the structural and compositional gradient profiles that cannot be produced commercially by the prior art.

### BRIEF DESCRIPTION OF THE SEVERAL VIEWS OF THE DRAWING

FIG. 1A is a schematic representation of an axial gradient in x-direction

FIG. 1B is a schematic representation of a radial gradient

FIG. 1C is a schematic representation of concentrations C_{A} of material A and G_{B} of material B in FGMs with axial and radial gradients

FIG. 2 is a schematic representation of cross sectional views of layers a and b

FIG. 3A is a schematic representation of possible shapes of original layers a and b for FGM with nonlinear gradient profiles

FIG. 3B is a schematic representation of possible shapes of original layers a and b for FGM with linear gradient profiles

FIG. 3C is a schematic representation of trapezoidal shapes of original layers a and b for FGM with nonlinear gradient profiles

FIG. 3D is a schematic representation of possible shapes of original layers a and b for FGM with nonlinear gradient profiles, where concentrations of materials A and B at some distance from the ends should be constant and then the concentrations should vary

FIG. 3E is a schematic representation of possible shapes of original layers a and b for FGM with non-monotonic gradient profile

FIG. 3F is a schematic representation of another possible shapes of original layers a and b for FGM with non-monotonic gradient profiles

FIG. 4 is a schematic representation of extrusion of bi-layer sandwich 9

FIG. 5A is a schematic representation of assembling layers a and b and deformation of the bi-layer sandwich by co-extrusion

FIG. 5B is a schematic representation of an orifice for die A

FIG. 5C is a schematic representation of an orifice for die B

FIG. 5D is a schematic representation of an orifice for a co-extrusion slot die

FIG. 6 is a schematic representation of extrusion of multilayer sandwich 11 into multilayer strip 12

FIG. 7 is a schematic representation of extrusion of multilayer sandwich 13 into multilayer strip 14

FIG. 8A is a schematic representation of narrowing an axial gradient profile

FIG. 8B is a schematic representation of widening an axial gradient profile FIG. 9 is a schematic representation of extrusion of sector-shaped strips

FIG. 10 is a schematic representation of extrusion of FGMs with a radial gradient

FIG. 11 is a schematic representation of winding up a strip with an axial gradient

FIG. 12A is a schematic representation of consolidated sandwich 15 used for cutting sector-shape elements to produce FGMs with a radial gradient

FIG. 12B is a schematic representation of cut sector-shape elements to produce FGMs with a radial gradient

FIG. 12C is a schematic representation of a cylinder assembled of sector-shape elements to produce FGMs with a radial gradient

FIG. 13A is a schematic representation of compaction die with a spherical cavity and a radial gradient FGM before pressing

FIG. 13B is a schematic representation of a spherical gradient FGM produced by pressing a radial gradient FGM into a compaction die with a spherical cavity

FIG. 14 is a schematic representation of dental implant position in bone

FIG. 15 is a schematic representation of cross-sectional views of layers a and b for example 1

FIG. 16 is a schematic representation of the porosity gradient profile for example 2

FIG. 17A is a schematic representation of the die for extrusion of layers a with a porosity gradient for example 2 (dimensions in mm)

FIG. 17B is a schematic representation of the die for extrusion of layers b with a porosity gradient for example 2 (dimensions in mm)

FIG. 18A is a schematic representation of the shape of the orifice for SAN17 die for example 4

FIG. 18B is a schematic representation of the shape of the orifice for PMMA die for example 4

FIG. 19A is a schematic representation of the multilayer roll with an axial gradient

FIG. 19B is a schematic of the multilayer roll in a compaction die before pressing

FIG. 19C is a schematic of a solid FGM with an axial gradient produced by compaction of the roll shown if FIG. 19B

### DESIGNATIONS

1—layer a;
2—layer b;
3—edge with 100% material A;
4—edge with 100% material B;
5a—extruder for layer a
5b—extruder for layer b
6—a co-extrusion die;
7—rollers;
8—a bi-layer sandwich;
9—a bi-layer composite strip;
10—an extrusion die with a rectangular orifice;
11—a multilayer sandwich assembled of strips 9;
12—a multilayer strip produced by extrusion of sandwich 11 through die 10;
13—a multilayer sandwich assembled of the strips 12;
14—a multilayer strip produced by extrusion of sandwich 13 through die 10;
15, 17—sandwiches assembled of strips 14;
16—a strip with narrow gradient;
18—a strip with wide gradient;
19—a sandwich assembled of gradient strips (x-gradient direction);
20—a sector-shaped die;
21—sector-shaped strips;
22—a cylinder assembled of sector-shaped strips 21;
23—a die with a circular orifice;
24—FGM with a radial gradient;
25—a cut segments with a radial gradient;
26—a reeled cylinder,
27—a sector-shaped element;
28—a cylinder assembled of elements 27
29—a piston;
30—d a FGM with a radial gradient;
31—a compaction die with a spherical cavity;
32—a FGM with a spherical gradient;
33—a crown;
34—an implant;
35—a cortical bone;
36—a cancellous bone;
38—a roll of multilayer FGM film;
39—a piston;
40—a compacted multilayer sandwich;

### Symbols

C_{A} and C_{B} are the concentrations of materials A and B in FGM
x is a distance from the beginning of the gradient profile;
L is a gradient breadth for an axial gradient profile;
t_{A} is the variable thicknesses of layers a;
t_{b} is the variable thicknesses of layers b;
tₐ₁ is the thickness of layer a at edge 3;
tₐ₂ is the thickness of layer a at edge 4
H is the maximal thickness of layers a and b and the thickness of the bi-layer sandwich assembled of layers a and b;
W is the width of layers a and b;
R is the gradient radius for a radial gradient profile;
h is the thickness of FGM.

### DETAILED DESCRIPTION OF THE INVENTION

The invention describes the methods of producing functionally graded materials with axial, radial and spherical gradients with a predetermined gradient profiles.

In the general case, axial gradient profile in FGM (dependences of concentrations C_{A} and C_{B} of materials A and B on relative profile distance x/L) is described as

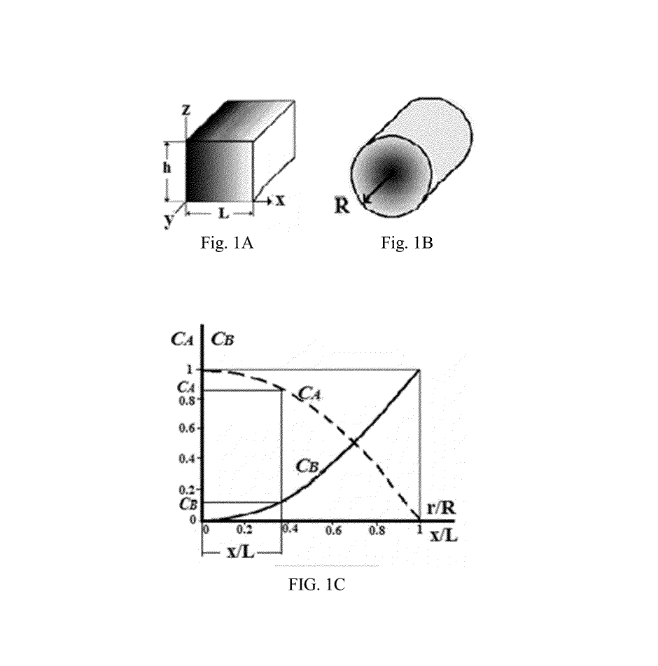

C_{A}=C_{A0}+(C_{AE}−C_{A0})f(x/L) and C_{B}=1−C_{A}(0≦x/L≦1); (1),

where L is the gradient breadth; x is the distance from the beginning of the gradient (FIG. 1); f(x/L) is the equation of the curve of the gradient profile. G_{A0} is the concentration of material A at the beginning of the gradient profile; C_{AE} is the concentration of material A at the end of the gradient profile.

If G_{A0}=0, C_{AE}=1 and f(x)=(x/L)ⁿ, C_{A}=(x/L)ⁿ. In this case, the shape of the gradient profile depends on n, which can take any value from 0 to infinity; n=0 corresponds to pure material A, n=∞ corresponds to pure material B. If n=1, the gradient profile is linear.

For the radial gradient, the gradient profiles may be described as

C_{A}=C_{A0}+(C_{AE}−C_{A0})f(r/R) and C_{B}=1−C_{A}(0≦r/R≦1), (2)

where r is the distance from the center of the cylinder with radius R (0≦r/R≦1).

FIG. 1A demonstrates a schematic representation of FGM with an axial gradient profile in x direction. A schematic representation of FGM with a radial gradient is shown in FIG. 1B. FIG. 1C demonstrates schematically dependences of concentrations C_{A} and C_{B} of materials A and B on relative gradient breadth x/L in axial FGMs and on relative radius r/R in the FGMs with radial gradients. L is the gradient breadth for an axial gradient profile; R is the gradient radius for a radial gradient profile; h is the thickness of the FGM.

A. Method for Making FGMs with Axial Gradients

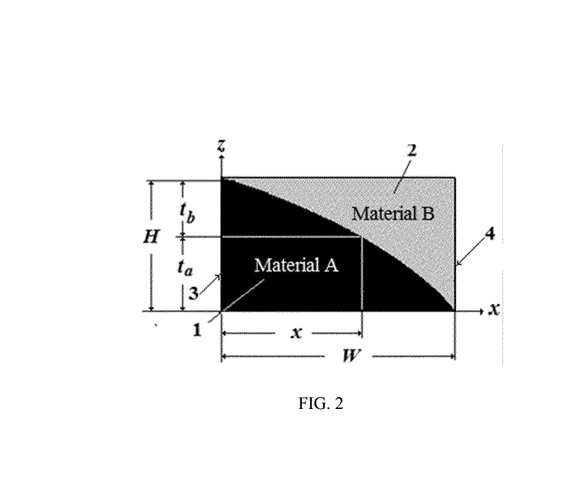

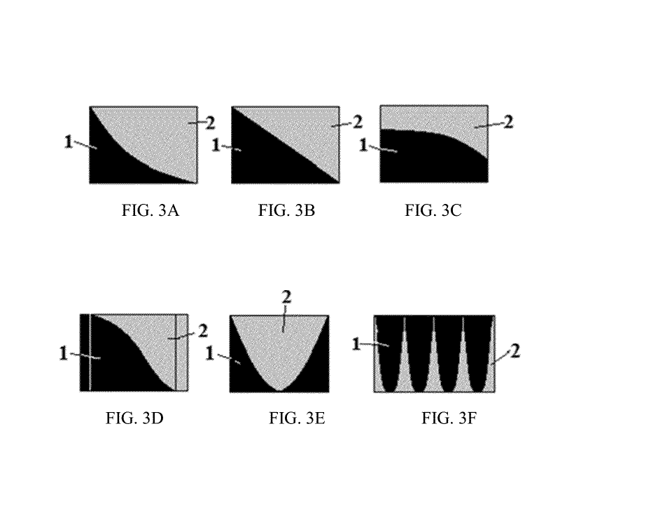

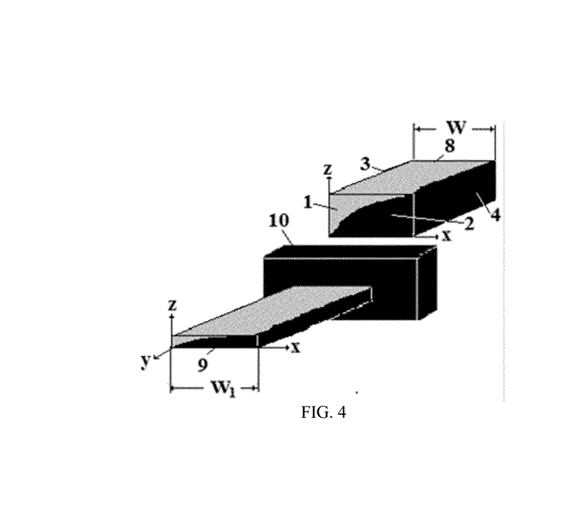

The first step of the process for making FGMs with an axial gradient calls for fabrication of layers a and b made of materials A and B correspondingly. Cross-sections of said layers have variable thicknesses. FIG. 2 shows a cross-sectional view of bi-layer sandwich assembled of layer a and layer b. Unlike the traditional multilayer materials with the layers of rectangular cross sections, the cross sections of layers a and b have a shape of right triangles with curvilinear or rectilinear hypotenuses (see FIG. 3A and FIG. 3B), or a shape of right curved or rectilinear trapeziums (FIG. 3C and FIG. 3D), or a combination of triangles with curvilinear or rectilinear hypotenuses (FIG. 3E and FIG. 3F).

The cross-sectional shape of layer b complements the cross-sectional shape of layer a so that the bi-layer sandwich formed by assembling layers a and b (so that the hypotenuses of the both layers coincide) has a rectangular cross section with thickness H and width W. Layers a and b can be produced by extrusion, rolling, die compaction, injection molding, slip casting, cutting, or any other suitable technique for the selected materials. Said layers are selected from the group consisting of polymers, metals, glasses, composites, or mixtures of different powders with plasticized binders.

The shapes of layers a and b depend on the required gradient profile. The relative thickness ta/H of layer a depends on the relative width x/W (see FIG. 2) in the same manner as the concentration of material A in a functionally graded material depends on the relative width of the gradient profile:

tₐ/H=tₐ₁/H+(tₐ₂/H−tₐ₁/H)f(x/W)0≦x/W≦1 (3),

tₐ₁ is the thickness of layer a at edge 3; tₐ₂ is the thickness of layer a at edge 4 (FIG. 2). In other words, the functions f(x/W) and f(x/L) are described with identical equations. For example, if in equation (1) f(x/W)=(x/W)ⁿ, then f(x/L)ⁿ, (x/L)ⁿ; or, if f(x/W)=cos(x/W), then f(x/L)=cos(x/L).

The dependence of relative thickness t_{b}/H of layer b on the relative distance x/W (see FIG. 2) is described by the equation

t_{b}/H=1−tₐ/H (4)

Some of the possible shapes of layers a and b are shown in FIG. 3A-3F. If the gradient profile should be nonlinear, the cross sections of layers a and b can have some of the shapes shown schematically in FIG. 3A or 3C. If a linear gradient is required, the layers a and b can have the shapes shown in FIG. 3B. If the gradient should be non-monotonic, cross-sectional shapes of the layers a and b may have the forms shown schematically in FIG. 3E or 3F. If the gradient is such that concentrations of materials A and B at some distance from the ends should be constant and then the concentrations should vary, the cross-sectional shape of layers a and b may have the form shown in FIG. 3D.

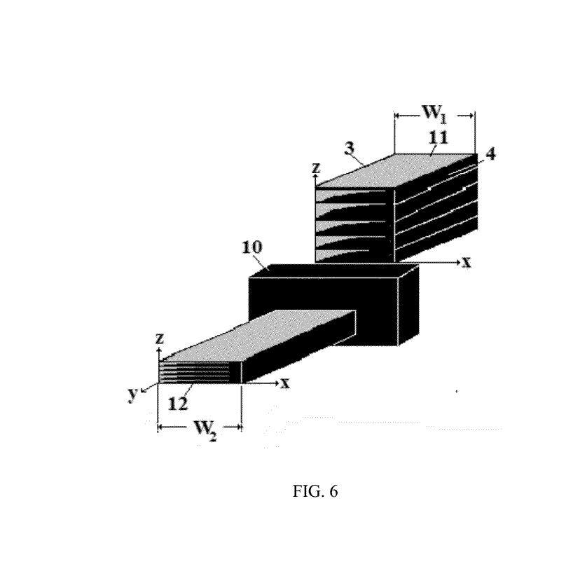

Layers a and b are assembled to form bi-layer sandwich 8 of rectangular cross section as shown in FIG. 4. Alternatively, multilayer sandwich 11, which includes a plurality of sandwiches 8, is assembled, as shown in FIG. 6. Sandwich 8 (or sandwich 11) is subjected to plastic deformation to reduce the sandwich thickness (and, correspondingly, the thicknesses of the each layer) and to produce bi-layer strip 9 (see FIG. 4) or multilayer strip 12 (see FIG. 6). The plastic deformation can be accomplished by extrusion, rolling, drawing, or other appropriate technique for the selected combination of the materials.

In another embodiment, sandwich 11 is assembled of strips 9.

FIG. 4 shows schematically the process of making bi-layer strip 9 by extrusion of bi-layer sandwich 8 using extrusion die 10 with a rectangular orifice. Width W₁ of strip 9 may be the same as width W of sandwich 8 or it may differ from W. The extrusion ratio may range from a few to thousands depending on the used materials and deformation techniques.

To provide the co-extrusion of layers a and b, i.e. their joint flow through an extrusion die, materials A and B should have equal or close viscosities at the extrusion temperature. Since in most cases the viscosity of material A differs from the viscosity of material B, the steps for their adjustment may be required. If the materials A and B are the mixtures of powders with plasticizing binders, the problem may be solved by adjusting the concentrations and compositions of the binders in the mixtures so as to provide equal viscosity of the mixtures at the extrusion temperatures.

If layers a and b are made of solid materials A and B (e.g., metals, glass or polymers), one of the possible solutions is to vary the heating temperature over the sandwich width. If material A is located along edge 3 of sandwich 8 and material B is located along edge 4 and if the extrusion temperature T_{A} for material A is higher than the extrusion temperature T_{B} for material B, the heating temperature of sandwich 8 should decrease from T_{A} to T_{B} between edges 3 and 4.

If material A and B are polymers, the viscosity adjustment can be achieved by modifications of the viscosities in the polymerization stage, for example, by adding plasticizers to the monomer of the material with a higher extrusion temperature.

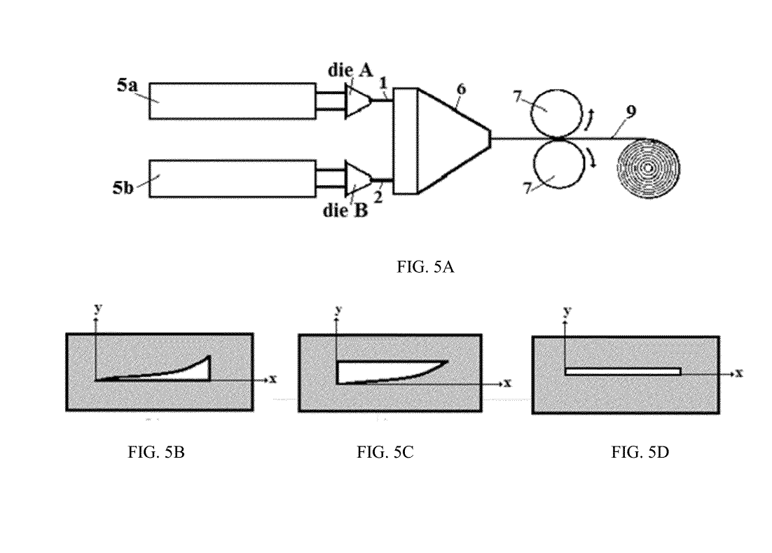

FIG. 5A illustrates one of the possible ways of producing bi-layer strip 9 using co-extrusion of layers a and b through die 6 with a rectangular orifice. Layers a and b are produced separately by extruding materials A and B using screw extruders 5a and 5b and dies A and B. The shapes of the orifices in said dies correspond to the required cross-sectional shapes of layers a and b (FIGS. 5B and 5C). Then both layers are fed to the co-extrusion die 6 of a rectangular shape (FIG. 5D) where they are co-deformed to produce bi-layer strip 9 of the required thickness. The temperatures of both extruders 5 have to be adjusted to match the viscosities of materials A and B when the melts are combined in die 6. As an option, multilayer strip 12 can be produced instead of the bi-layer one, if 2n extruders 5 supply n layers a and n layers b (n=2, 4, 6 . . . ).

If strips 9 or 12 are thin (e.g., polymer films), their stacking can be performed by reeling (see FIG. 5A). The co-extrusion shown in FIG. 5A can be performed using screw or ram extruders; the co-extrusion shown in FIG. 6 requires ram extruder.

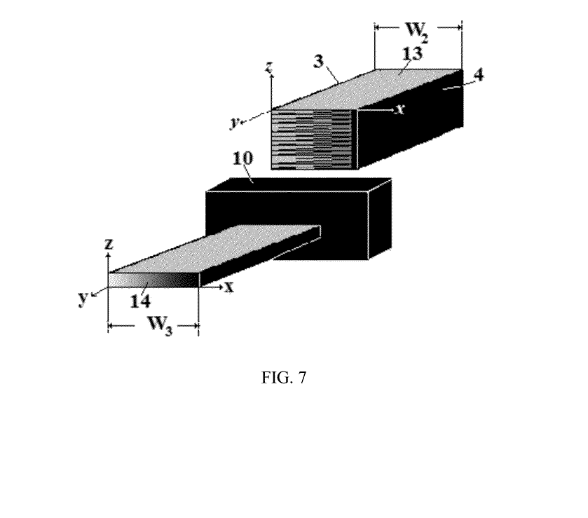

If the required thickness of layers a and b in strip 12 is not achieved, then, a plurality of strips 12 is stacked into sandwich 13 (FIG. 7) so that the edges of identical composition are placed one above the other, and further multilayer composite strip 14 is produced by extrusion of sandwich 13 through rectangular die 10. A plurality of strips 12 can be obtained by cutting strip 12 into the segments of the pre-assigned length. Cutting can be performed either in a continuous mode during the deformation or after deformation. If strip 12 is thin, stacking can be performed by its reeling. Width W₃ of strip 14 may be the same as the width W₂ of sandwich 13 or W₃ may differ from W₂.

If the desirable thickness of layers a and b is not achieved in strip 14, the process is repeated as many times as necessary to attain the goal.

For a layered material, the critical layer thickness t_{c}, below which the material behaves as macroscopically homogeneous, depends on the structure of the used materials A and B and on their application. For example, if the materials A and B are powders and the goal is to obtain FGM with a continuous gradient of mechanical or thermal properties, the value of t_{c} is commensurable with the size of the powder particles (from several to dozens of microns). If the materials A and B are polymers and the goal is to produce a FGM with optical homogeneity, theoretically t_{c} must be less than ¼λ, where λ is the wavelength of the light, i.e. less than 100 nm. In practice, this value is 5-10 nm.

In many cases, after 2 or 3 extrusions, the desired thickness of the layers can be achieved.

If the materials A and B are feedstocks consisting of the powders mixed with plasticized binders, the thicknesses of sandwiches 11 and 13 may be easily reduced in the process of slot extrusion by a factor of 40-50. Thus, if the initial maximal thickness of each layers a and is 2-4 mm, after extrusion it can be reduced to 40-100 μm. If the powders of feedstocks are finer than 40-100 μm, the slot extrusion of sandwich 13 can reduce the maximal thickness of layers a and b in strip 14 to 0.5-1 μm. As a result, the adjacent layers with the powder size higher than 1 μm will be intermixed in z-direction retaining concentration gradient in x-direction.

For the case when materials A and B are thermoplastic polymers, state-of-the-art co-extrusion technologies allow production of the 20-50 μm thick polymer films in strip 9. That means that the maximum thickness of layers a and b in sandwich 11 can be 20-50 μm. The further slot extrusion of a 50 mm thick sandwich 11 into 0.5 mm thick strip 12 decreases the maximal thickness of layers a and b to 200-500 nm. In many cases such thicknesses can provide the desirable continuous gradient because when the layer thicknesses reach the nanoscale level, the difference in the rheological properties of materials A and B causes intermixing of the adjacent layers in z-direction, while maintaining the desirable gradient in x-direction.

If the desirable maximal thickness of layers a and b is not achieved in strip 12, further 50 mm thick multilayer sandwich 13 is assembled from strips 12 and extruded through a slot die to produce 0.5 mm thick strip 14 and correspondingly to reduce the thickness of layers a and b to 2-5 nm. Thus, three extrusions allow obtaining polymer FGMs with maximal layer thicknesses less than 5 nm.

The surfaces of the deforming sandwiches may be covered with an additional protective peel layers that are removed after each deformation to prevent damage of the surfaces.

Different applications may require FGMs with different breadth of concentration gradients—from fractions of millimeter to several centimeter or decimeters or meters. If the width of strips 12 or 14 differs from the desirable gradient breadth, narrowing or widening of the gradient can be performed.

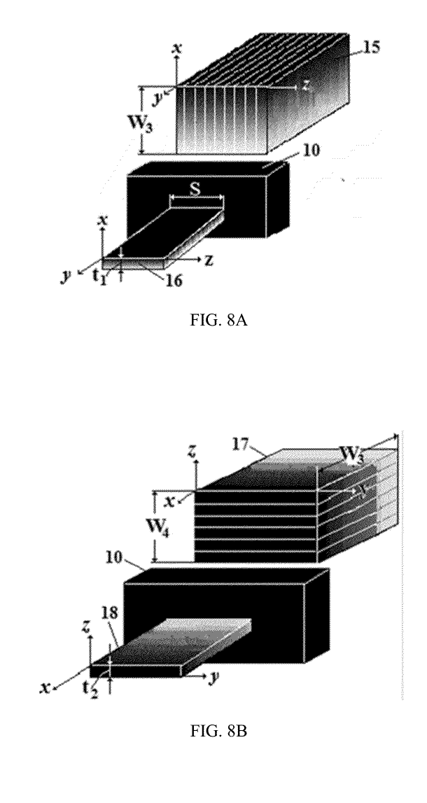

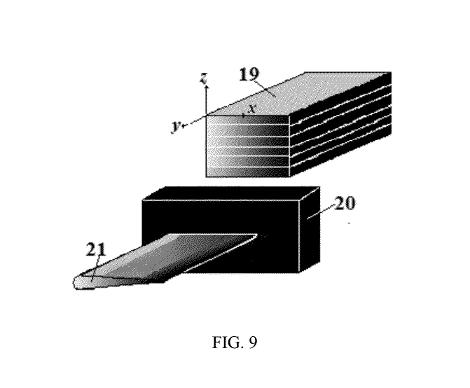

As shown in FIG. 8A, the narrowing of the gradient can be performed by extrusion of sandwich 15 obtained by stacking strips 14 through slot die 10, whose height t₁ corresponds to the desirable gradient breadth. In doing so, sandwich 15 is placed in the extrusion barrel so that the gradient direction x is perpendicular to the slot width S. Elongation occurs in the y-direction and thinning takes place in the x-direction. As a result, the gradient breadth of produced strip 16 is equal t₁.

Widening the gradient breadth is achieved by stacking strips 14 into sandwich 17 and by elongation of said sandwich in x-direction (along the gradient) using extrusion through slot die 10 as shown in FIG. 8B. By doing so, the gradient breadth of the produced FGM can be controlled by the extrusion ratio and can range from centimeters to meters. The required thickness of the final product can be obtained by stacking produced strips 18 and consolidating the produced sandwich in a die.

If materials A and B are feedstocks consisting of powders with binders, the produced green FGMs are subjected to debinding and sintering. Metal and ceramic FGMs can be heat-treated to homogenize materials in z-direction (perpendicular to the gradient direction x). The homogenizing annealing should not lead to a noticeable diffusion in x-direction, so as not to change the preset concentration gradient. Since the diffusion paths in z-direction are usually orders of magnitude shorter than those in the x-direction, this can be achieved by the selection of right temperature and time of the heat treatment.

B. Method for Making FGMs with Radial Gradients

Functionally graded materials with radial gradients are produced from the FGMs with axial gradients. The dependence of relative thickness ta/H of initial layer a on relative distance x/W from its edge 3 follows the equation (3) similar to the equation (2) for the radial gradient profile, i.e. for dependence of concentration C_{A} of material A on the relative radius r/R for FGMs with a radial gradient. The dependence of relative thickness t_{b}/H of layer b on x/W follows the equation (4):

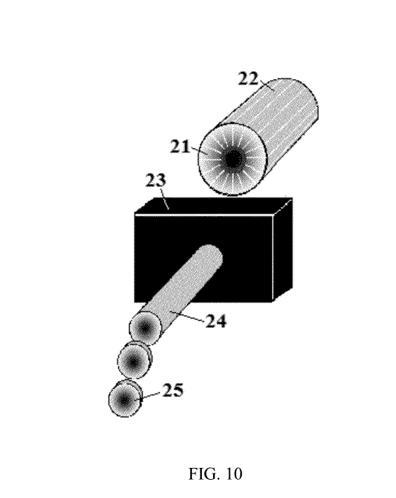

In one embodiment, strips 14 (FIG. 7) are stacked into sandwich 19 (FIG. 9) so that all their edges of identical composition are arranged one above the other and extruded through die 20 with a sector-shape orifice with the central angle of 360°/N (where N is integer and N>2) to produce sector-shaped strip 21. Rolling, cold or hot die compaction, or any other suitable deformation technique can be used instead of extrusion. then N segments of strip 21 are assembled into cylinder 22 so that the edges comprising 100% material A are located in the center of said cylinder 22 and all the edges comprising 100% material B are located at the periphery of cylinder 22 (FIG. 10) and cylinder 22 is subjected to extrusion through die 23 with a circular orifice or to rolling, drawing, die compaction, isostatic pressing, or any other appropriate technique to consolidate cylinder 22 and produce solid material 24 and parts 25 with a radial gradient of concentrations. FIG. 10 demonstrates schematically the process of consolidation and deformation of the cylinder 22 using the extrusion process.

In another embodiment, sandwich 19 can be produced by stacking strips 12 or strips 9. Which of the strips should be chosen for sandwich 19 depends on the requirements to the thicknesses of layers a and b in the final FGM.

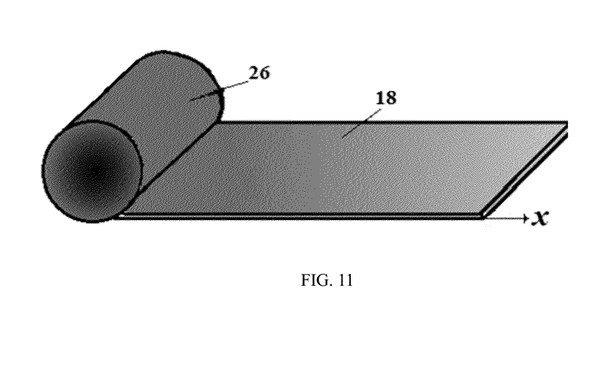

In another embodiment, a FGM with a radial gradient is produced by scrolling thin strip 18 with wide axial gradient in x-direction (see FIG. 8B) into roll 26 (FIG. 11). Strip 18 should be long enough to produce roll 26 of the necessary diameter (FIG. 11). Then roll 26 is subjected to the consolidation by extrusion, rolling, cold or hot die compaction, etc. to obtain a radial gradient FGM of the required size.

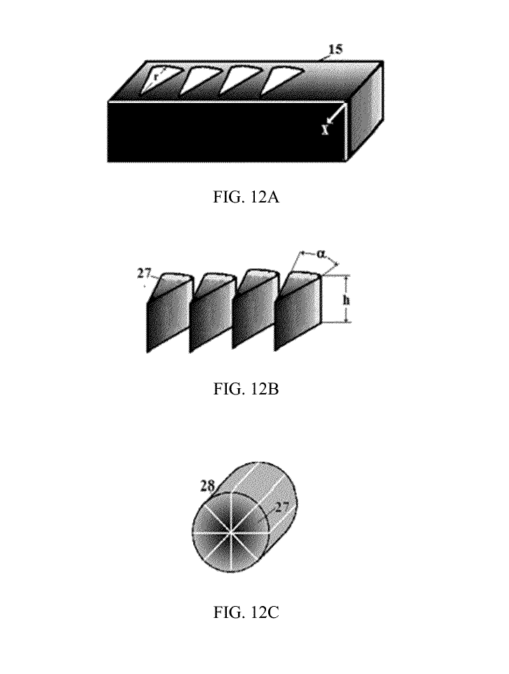

In another embodiment, consolidated sandwich 15 (see FIG. 8A) is cut or punched to make sector-shape parts 27 (FIGS. 12A and 12B). Median radius r of parts 27 coincides with x-axis of sandwich 15. Central angle α of the sector should be 360°/N, where N is integer (N>2). N said parts 27 are assembled into circular cylinder 22 (FIG. 10), which is subjected to consolidation by extrusion, rolling, die compaction or any other appropriate technique.

All three options allow low cost production of redial gradient lenses as large as decimeters in diameter and as small as tenths of millimeter in diameter. For example, gradient index optical fibers or tiny rods can be produced by extrusion or drawing of cylinder 22 (FIG. 10) or of roll 26 (FIG. 11). Such fibers and rods can be used as optic collimators and focuser assemblies.

C. Method for Making FGMs with a Spherical Gradient

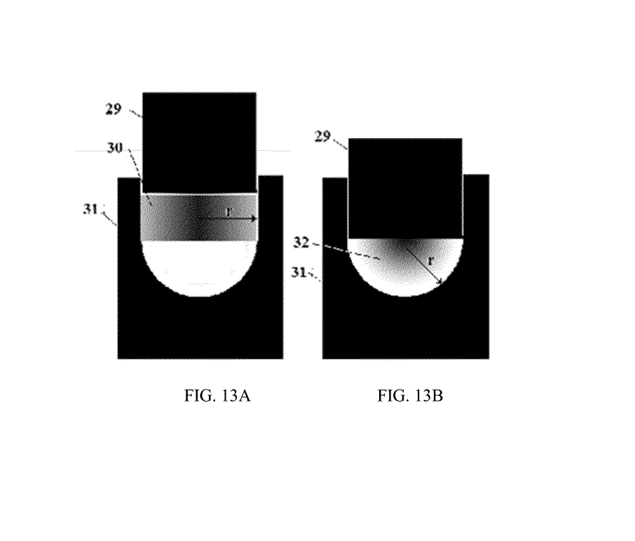

FIGS. 13A and 13B demonstrate schematically the process of fabrication of FGM with a spherical gradient from FGM with a radial gradient. Cylindrical part 30 with a radial gradient is placed in compaction die 31 and pressed in its spherical cavity using punch 29. As a result, part 32 with a spherical gradient is produced.

In another embodiment, cylinders 22 shown in FIG. 10, or cylinders 28 shown in FIG. 12C or rolls 26 shown in FIG. 11 are used instead of solid cylinder 30.

The present invention includes all functionally graded materials with axial, radial and spherical gradients with a predetermined shape of gradient profiles produced by the described methods including metal-ceramic FGMs, metal-metal FGMs, glass-glass FGMs, polymer-polymer FGMs, materials with graded porosity, materials with graded distribution of the phases in a matrix, optical lenses with axial, radial and spherical gradient of refractive index, and others.

While the present invention has been described in terms of particular embodiments and applications, in both summarized and detailed forms, it is not intended that these descriptions in any way limit its scope to any such embodiments and applications, and it will be understood that many substitutions, changes and variations in the described embodiments, applications and details of the method and system illustrated herein and of their operation can be made by those skilled in the art without departing from the spirit of this invention.

### EXAMPLES

### Example 1

### Fabrication of Axial FGM Hydroxyapatite-Titanium

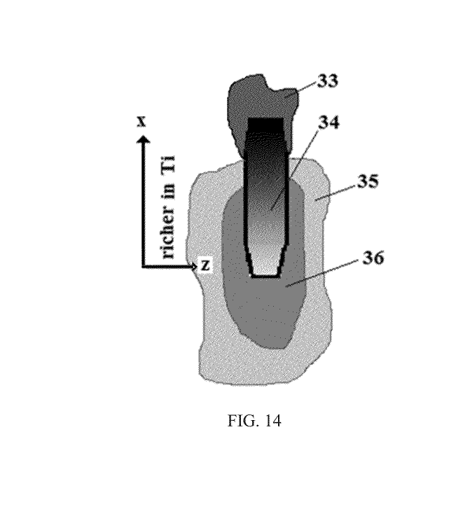

Titanium and hydroxyapatite (HAP) are used as the materials for dental implants due to their high compatibility with hard tissue and living bone. Since hydroxyapatite is actually one of the principal compositions of bone and other mineral tissues, Ti-HAP FGM could bring about better bio mechanical, microstructural, and compositional compatibility with the native host. For better matching mechanical properties, FGM dental implants composed of a mixture of titanium and HAP should have a continuous graded configuration the region of implant 34 (see FIG. 14) connecting to the cortical 35 and cancellous 36 bones should contain more HAP and then gradually become richer in Ti as the implant gradually goes to crown 33.

Material A is the feedstock comprising 51 vol % spherical titanium powder (particle size was 45 μm) and 49 vol % binder (69% paraffin wax; 15% polypropylene; 15% carnauba wax; 1% stearic acid). Material B is the feedstock comprising mixture of 46 vol % agglomerated sphere-like HAP powder with the 5 μm particle size and 54 vol % of the same binder.

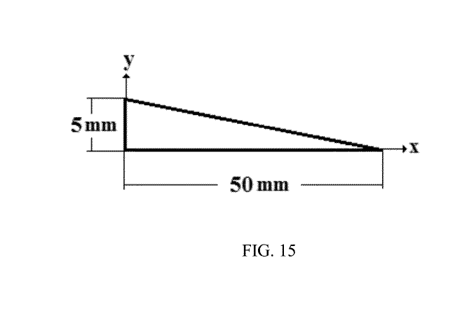

The 150 mm long layers a and b were made from materials A and B using a die compaction. The cross sections of the both layers have the shape of right triangle with the 5 mm and 50 mm legs shown in FIG. 15.

Layers a and b were assembled so that their hypotenuses coincided to form a bi-layer sandwich (150×50×5 mm). of rectangular cross section The set of 20 said sandwiches was placed in the 100 mm×50 mm barrel of a ram extruder and extruded through the 2 mm×50 mm slot die to reduce the thickness of said sandwich from 100 mm to 2 mm. As a result, a 2 mm thick and 50 mm wide the strip of a rectangular cross-section consisting of 40 alternating Ti and HAP green triangle layers with the thicknesses varying from 100 μm to 0 along the x axis was obtained.

The sandwich assembled of 50 said strips was placed in the same 100 mm×50 mm barrel of the ram extruder and extruded through the 2 mm×50 mm slot die to reduce the thickness of said sandwich again from 100 mm to 2 mm. As a result, the new 2 mm thick and 50 mm wide strip of a rectangular cross-section comprising 4000 alternating Ti and HAP triangle layers. The thicknesses of the each layer was gradually changing along axis x from 2 μm to 0.

Since the maximal thickness of each layer was smaller than the size of the used powders, the adjacent layers were mixed with one another in the z-direction while maintaining the concentration gradient in the x-direction.

In the produced strip the breadth of the gradient profile was 50 mm. The required gradient breadth was 8 mm. Thus, the sandwich assembled of 50 said new strips was placed in the same 100 mm×50 mm barrel of the ram extruder, as shown in FIG. 8A, and extruded through the 8 mm×50 mm slot die to reduce the thickness of said sandwich from 50 mm to 8 mm, The 8 mm long green body with the 8 mm×8 mm cross section was cut from the produced 8 mm×50 mm strip and subjected to debinding in chemically pure argon. Then sintering in the vacuum of 0.001 Pa at 1300° C. was performed. After sintering, the size of the sample was reduced to 6×6×6 mm. The sintered sample was machined to obtain the required 5 mm in diameter rod with the smooth continuous axial gradient.

### Example 2

### Fabrication of Hydroxyapatite with an Axial Porosity Gradient

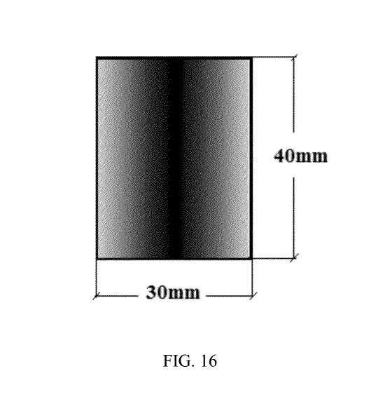

Hydroxyapatite (HAP) has attracted a great deal of attention as a scaffold material for bone tissue applications due to its high osteoconductivity and bioactivity. The goal was to produce hydroxyapatite FGM with the reducing porosity P from 50% in the beginning of the gradient profile to 20% in the middle of the profile and then to increase the porosity from 20% in the middle to 50% in the end of the gradient profile. The breadth of the gradient L 30 mm. The porosity variation should follow the function P=0.2−2.4(x/L)³, if −0.5≦x/L≦0 and P=0.2+2.4(x/L)³ if 0≦x/L≦0.5 (FIG. 16),

First, blends A and B were prepared. Blend A included 80 vol % HAP powder (average particle size 100 μm)+20 vol % polypropylene powder with the average particle size 150 μm, Blend B included 50 vol % HAP powder+50 vol % of the same polypropylene powder, which was used as a pore agent. Material A was prepared by mixing 50 vol % of blend A with 50% binder (69% paraffin wax; 15% polypropylene; 15% carnauba wax; 1% stearic acid). Material B was prepared by mixing 44 vol % blend B with 56% of the same binder.

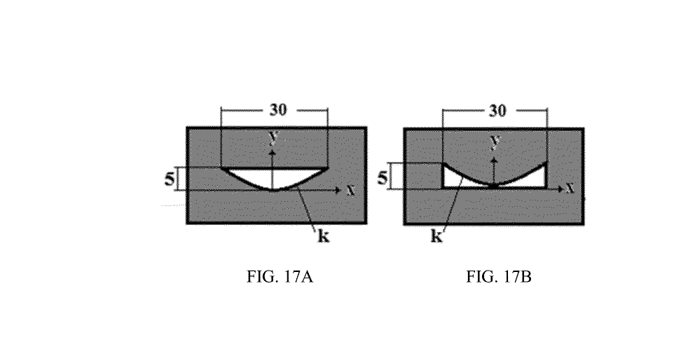

Layers a were made by extrusion of material A trough the die shown in FIG. 17A and layers b were made by extrusion of material B through the die shown in FIG. 17B. The cross-sections of the layers produced corresponded to the shape of their dies.

Layers a and b were assembled into a hi-layer sandwich of rectangular cross section (their curve lines k shown in FIGS. 17A and 17B coincided). The set of 20 said sandwiches was placed in the 100 mm×30 mm barrel of the ram extruder and extruded through the 1 mm×30 min slot die to reduce the thickness of said sandwich from 100 mm to 1 mm. The produced 1 mm thick and 30 mm wide strip of a rectangular cross-section included 40 alternating curvilinear layers a and b. The thicknesses of layer a increased from 0 to 50 μm, when x/L changed from periphery to the middle of the cross-section and then decreased from 50 μm to 0, when x/L changed from the middle to periphery. The thickness of layer b decreased from 50 μm in the periphery to 0 in the middle.

Since the maximal thickness of each layer in the produced strip was smaller than the size of the used powders, there was no need for the further thicknesses reduction. Twenty five of 40 mm long segments of said strip were placed in a compaction die and subjected to consolidation under pressure of 5 tons at 60° C. The produced 25×30×40 mm green body was subjected to debinding followed by sintering at 1250° C. for 1 hr in air. As a result, the HAP sample with the pore size of 120 μm and with the prescribed porosity gradient along its 30 mm width was obtained.

### Example 3

### Fabrication of WC-Co Alloys with an Axial Gradient

WC-Co functionally graded materials would be ideal for cutting inserts and wear-resistant linings in the mineral processing industry. The gradation enhances the toughness of the ceramic face and prevents ceramic-metal debonding because the graded transition in composition between metal and ceramic essentially reduces the thermal stresses and stress concentrations. They combine high abrasion resistance (WC face) with high impact resistance and convenience (weldable/boltable to metal) supports.

Materials: Material A was the feedstock comprised 52 vol % of the mixture (tungsten carbide powder+2% cobalt powder) and 48 vol % binder; material B was the feedstock comprised 55 vol % Co powder and 45 vol % binder. Average particle size of WC powder was 4 μm, average particle size of Co powder was 17 μm. Binder composition: 69% paraffin wax; 15% polypropylene; 15% carnauba wax; 1% stearic acid.

The 150 mm long layers a and b were made from material A and material B using die compaction. The cross sections of the both layers have the shape of right triangle with legs 5 mm and 50 mm shown in FIG. 15.

Layers a and b were assembled into a bi-layer sandwich of rectangular cross section (the hypotenuses of the triangles coincided). The set of 20 said sandwiches was placed in the 100 mm×50 mm barrel of the ram extruder and extruded through the 2 mm×50 mm slot die to reduce the thickness of said sandwich from 100 mm to 2 mm. As a result, a 2 mm thick and 50 mm wide strips of a rectangular cross-section consisting of 40 alternating (WC+2%) and Co green triangle layers with the thicknesses varying from 100 μm to 0 along x axis were obtained.

50 said strips were assembled into a sandwich, which was placed in the same 100 mm×50 mm barrel of the ram extruder and extruded through the 2 mm×50 mm slot die to reduce the thickness of said sandwich from 100 mm to 2 mm. As a result, a new 2 mm thick and 50 mm wide green strip of a rectangular cross-section comprising 4000 alternating (WC+2%) and Co triangle layers. The thicknesses of the each layer linearly changed along axis x from 2 μm to 0.

Twenty said new strips were assembled into 40 mm×40 mm×50 mm green sandwich, which was placed in the 50 mm×40 mm compaction die, compressed under 10 ton force at 60° C., and subjected to debinding followed by sintering in hydrogen at 1400° C. After sintering, the sample has a linear gradient of tungsten carbide from 98% in one surface to 0% in the opposite surface.

### Example 4

### Fabrication of Radial Gradient Optical Lenses (GRIN Lenses)

The goal was to produce a 100 mm in diameter transparent polymer cylinder with a variable refractive index changing gradually in radial direction from n_{A}=1.49 in periphery to n_{B}=1.57 in the center. The gradient profile should follow the equation n=n_{A}−(n_{A}−n_{B})(r/50)² (0≦x≦50).

Materials: Material A—poly(styrene-co-acrylonitrile) with 17% acrylonitrile (SAN17); material B—poly(methyl methacrylate) (PMMA). The refractive indexes of materials A and B are n_{A}=1.49 and n_{B}=1.57.

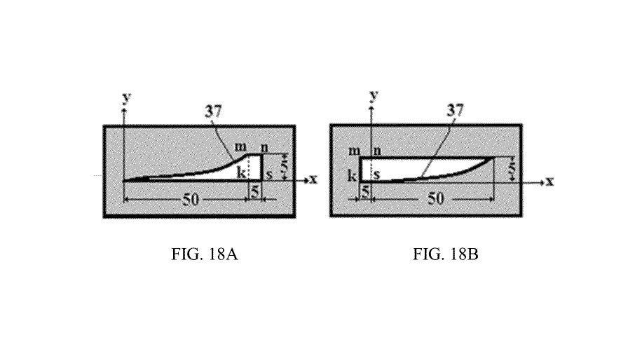

Two screw extruders 5a and 5b (FIG. 5) were used to extrude two separate layers a and b from SAN17 and PMMA correspondingly. The melt stream from each extruder flowed into separate dies A and B whose orifices had a shape of curved right triangles with the curve line described by the parabolic equation y=5(x/50)² (FIGS. 18A and 18B). Rectangular sections mnsk of the orifices were added to trim the faulty side edges of the extruded strips.

Two produced layers a and b (SAN17 and PMMA) with the cross sections that inherited the shapes of the respective dies were combined and co-extruded in a slot die 6 (FIG. 5). Extruder temperatures were adjusted to ensure that the viscosities matched when the melts were combined in die 6. The 50 μm thick bi-layer film (similar to strip 12 in FIG. 6) with the 50 mm breadth concentration gradient from 100% SAN17 to 100% PMMA in x-direction was extruded onto a chill mill rolls and reeled up. Stacking said films was performed in the process of reeling. The side edges of said strip were trimmed from the each side. While the thickness of the bi-layer film was constant, the thickness of the each layer varied gradually along the film width from 50 μm to the value close to zero.

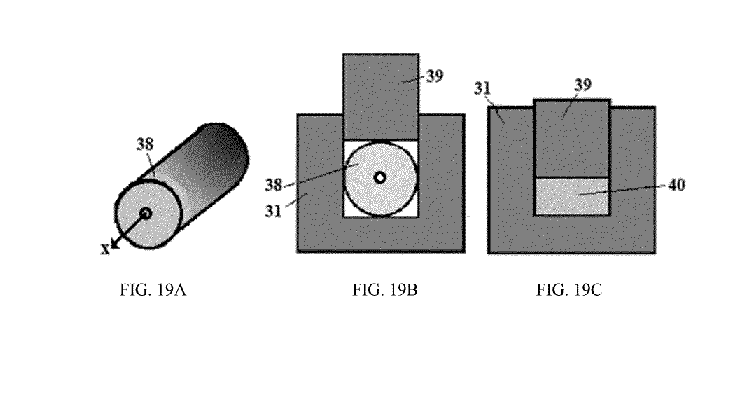

The produced multilayer roll 38 (FIG. 19A) was placed in compaction die 31 (FIG. 19B) and compressed to produce the new 50 mm thick and 50 mm wide multilayer sandwich 40 of rectangular cross section as shown in FIG. 19C. Set of four sandwiches 40 was placed in the rectangular barrel of a ram extruder. The 5 mm thick inserts of SAN-17 and PMMA were inserted in the corresponding rectangular die sections mnsk to compensate for the cut edges. The sandwiches with said inserts were extruded trough the slot die to produce a new 50 μm thick and 50 mm wide strip. The thickness of each of 1000 layers of this new strip varied gradually along its width from 0.5 μm to zero. The side edges of said strip were trimmed (5 mm from the each side).

Said new strip was reeled up, the roll was compacted in a die to obtain the new 50 mm thick and 50 mm wide multilayer sandwich of rectangular cross section. Four said multilayer sandwiches were placed in the same rectangular barrel of the s ram extruder as in and the 5 mm thick inserts of SAN-17 and PMMA were inserted in the corresponding rectangular die sections mnsk to compensate for the cut edges. The sandwiches with the said inserts were extruded trough the slot die to produce further 50 μm thick and 50 mm wide strip. The thickness of each of 10⁵ layers of the produced further strip varied gradually along the width from 5 nm to zero. The side edges of said strip were trimmed, it was reeled up, the roll was compacted in a die to obtain the new 50 mm thick and 50 mm wide multilayer sandwich of rectangular cross section with 10⁸ alternating 5 nm thick layers. Said sandwich was cut to make parts 27 of circular sector cross-section with radius r=50 mm, height h=45 mm and central angle α=45° (FIG. 12C). 100% SAN-17 was in the center of the sector and 100% PMMA was in its periphery. Eight said parts 27 were assembled into 100 mm diameter circular cylinder 28, which was placed in a 100 mm diameter compaction die and consolidated by the 5 tons force at 130° C. As a result, the 100 mm in diameter and 45 mm thick transparent solid cylinder 30 with the radial gradient concentration from SAN 17 to PMMA was produced. Since refractive index of SAN-17 is n_{A}=1.57 and refractive index of PMMA is n_{B}=1.49, said cylinder had the continuous radial gradient of refractive index, which varied from 1.57 in the center to 1.49 in the periphery following the parabolic equation n=n_{A}−(n_{A}−n_{B})(r/50)² (0≦x≦50). Such refractive index gradient allows utilization of the produced part as flat lenses.

### Example 5

### Fabrication of Optical Lenses with the Spherical Gradient

Grin lenses with the spherical refraction index gradient were produced by placing the cylinder with the parabolic radial gradient obtained in example 4 in a compaction die and pressing it in the spherical cavity at temperature 130° C. (FIGS. 19A, 19B and 19C).

1. A method of producing functionally graded materials with a pre-assigned axial gradient profile of materials A and B, comprising the steps of:
i. forming layers a from material A, wherein said material A is selected from the group consisting of polymers, metals, glasses, composites, or mixtures of powders with plasticized binders and wherein the relative thickness of said layers a depends on their relative width in the same manner as the concentration of material A in a functionally graded material depends on the relative width of the gradient profile;
ii. forming layers b from material B, wherein said material B is selected from the group consisting of polymers, metals, glasses, composites, or mixtures of powders with plasticized binders and wherein the relative thickness of said layers b depends on their relative width in the same manner as the concentration of material B in the functionally graded material depends on the relative width of the gradient profile
iii. assembling said layers a and b into the gap-free sandwiches of a rectangular cross-section;
iv. assembling a stack of said sandwiches of a rectangular cross-section so that their edges of identical composition are arranged one above the other;
v. deforming the sandwich produced in step (ii) or a stack of sandwiches produced in step (iii) using extrusion, rolling, drawing, die compaction or any other appropriate technique to reduce the thickness of layers a and b and to produce a composite strip of rectangular cross-section;
vi. stacking a plurality of said composite strips produced in the previous step into a further stack, wherein the edges of said strips of identical composition are arranged one above the other;
vii. deforming said further stack produced in the previous step using extrusion, rolling, drawing or any other appropriate technique to produce a further multilayer composite strip of rectangular cross-section with a composition gradient along its width and with the layers a and b thinner than in the previous step;
viii. repeating steps (v) and (vi), if necessary, until the maximal thickness of said layers a and b in the multilayer composite strip is decreased to the pre-assigned value and the concentration gradients of materials A and B along the width of said multilayer composite strip reaches the desired level of continuity.

2. The method of claim 1, wherein material A is a feedstock comprising a powdered form of material A mixed with a binder material and material B is a feedstock comprising a powdered form of material B mixed with a binder material, and the green FGM parts produced of said feedstocks are subjected to debinding followed by consolidation by sintering, cold or hot pressing, hydraulic or isostatic pressing, extrusion, rolling or any other appropriate consolidation technique.

3. The method of claim 1, wherein material A or both materials A and B contain pore-formers.

4. The method of claim 1, wherein deforming of stacks in steps (v), (vii) and (viii) is performed at variable temperatures over the width of said stacks to equalize the viscosities of materials A and B over the width of said stacks.

5. The method of claim 1, wherein assembling layers a and b in step (iii), assembling a stack in step (iv) and stacking in steps (vi) and (viii) is performed by reeling.

6. A method of producing functionally graded materials with a pre-assigned radial gradient profile of materials A and B, comprising the steps (i), (ii), (iii), (iv), (v), (vi), (vii) and (viii) of claim 1, followed by the steps of:
ix. stacking the multilayer composite strips of rectangular cross-section produced in step (vii) (or in step (viii), if step (viii) is performed) of claim 1 so that all edges of said strips of identical composition are arranged one above the other;
x. fabricating elements having the shape of a circular sector with the central angle of 360°/N (where N is integer) from the stack produced in step (ix) using extrusion, rolling, drawing, cutting, punching, or any other appropriate technique;
xi. assembling N said elements of sector shape into a cylinder so that the edges comprising 100% material A are located in the center of said cylinder and all the edges comprising 100% material B are located at the periphery of said cylinder;
xii. consolidating said cylinder produced in step (xi) using extrusion, rolling, drawing, die compaction, isostatic pressing, or any other appropriate technique.

7. The method of claim 6, wherein stacking in step (ix) is performed by reeling.

8. A method of producing functionally graded materials with a pre-assigned radial gradient profile of materials A and B, wherein a strip with an axial gradient of concentrations is wound up along the gradient direction into a roll and said roll is subjected to consolidation by die compaction, extrusion, rolling, or any other appropriate technique.

9. A method of producing functionally graded materials with a spherical gradient profile of materials A and B, wherein a cylinder with a radial gradient of composition of materials A and B is placed in a compaction die with a spherical cavity and pressed into said cavity.

10. Functionally graded structures produced by the methods of claim 1

11. Functionally graded structures produced by the methods of claim 6

12. Functionally graded structures produced by the methods of claim 7.

13. Functionally graded structures produced by the methods of claim 8.

14. Functionally graded structures produced by the methods of claim 9

15. Lenses with an axial gradient of refractive index produced by the methods of claim 1

16. Lenses with a radial gradient of refractive index produced by the methods of claim 6

17. Lenses with a radial gradient of refractive index produced by the methods of claim 7

18. Lenses with a radial gradient of refractive index produced by the methods of claim 8

19. Lenses with a spherical gradient of refractive index produced by the methods of claim 9
